(19) United States
(12) Patent Application Publication
(10) Pub. No.: US 2008/0258334 A1
(43) Pub. Date: Oct. 23, 2008

(54) Method and Device for the Production of At Least One Container Filled With a Medium

(76) Inventor: Bernd Hansen, Sulzbach-Laufen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/575,358

(22) PCT Filed: Oct. 9, 2004
(86) PCT No.: PCT/EP2004/011327

§ 371 Date: Apr. 11, 2006

(30) Foreign Application Priority Data
Oct. 15, 2003 (DE) 10347908.2

(51) Int. Cl. B29C 47/00; D01D 5/24

(52) U.S. Cl. 264/209.1; 425/376.1

(57) ABSTRACT

The invention relates to a method and to a device for the production of at least one container filled with a medium, said container being made of a plastic material. The plastic material is extruded in a tubular manner and is applied to the inner walls of a moulding tool in order to mould the respective container by means of differential pressure. The respective container is filled with a medium via the inlet opening with the aid of a filling device and the inlet opening of the container is closed by a lock. A coextrusion method is used for the extrusion of different plastic materials, whereby the respective container is made at least partially of several layers of plastic materials. At least one of the layers is used at a barrier layer.

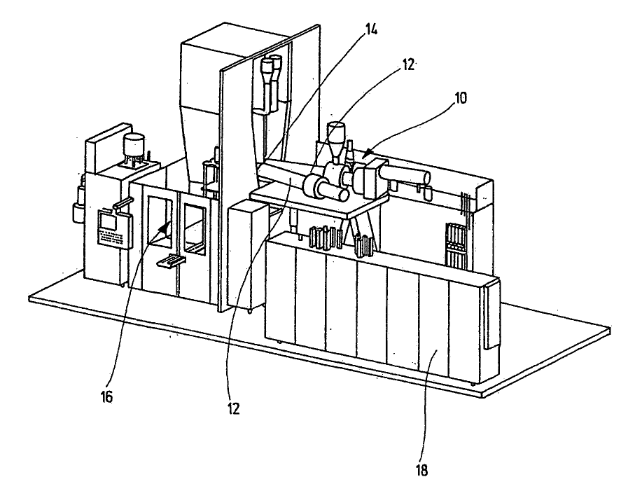

The invention relates to a method for the production of at least one container of a plastic material filled with a medium, in which
the plastic material is extruded in a tubular shape and is placed against the inside walls of a molding tool for molding the respective container by means of differential pressure,
the respective container is filled with the medium by way of its fill opening with a filling means, and
the fill opening of the container is closed by sealing.

The invention also relates to a device for carrying out this process.

A generic process for producing liquid-filled containers of thermoplastic material and a device having an extrusion head for carrying out this process are disclosed by DE 38 32 566 C2. In the known process the extrusion of the plastic takes place in the form of a wide flat tube, the molding of ampule-like containers in particular taking place from a flat tube in the form of a container belt having container strips arranged in succession in the longitudinal direction of the belt from the containers molded at the same time and when molding the containers a side waste strip being formed on at least one of the two edges of the container belt. This yields a major simplification of handling and by a single cutting or punching process a container strip which has all the containers produced and filled per working cycle can be cut off from the side waste strip. The known process of the initially named type, which has become known in the trade under the brand name “Bottelpack®”, makes it possible to economically produce, fill and seal containers, even under aseptic conditions. It is therefore widely used. In all cases in which the contents are oxygen-sensitive, where aroma and water vapor barriers or the like are necessary, it is however then necessary to provide the container with repackaging, for example in the form of aluminum packaging, which is additionally filled with an inert gas, such as nitrogen for example, in order in this way to form an effective barrier against the environment. But this is associated with a respective additional production effort; this increases product costs.

EP 0 930 238 A1 has already proposed providing filled and sealed plastic containers, molded using extrusion blowing, spray blowing, or injection molding technology, and filled and sealed in-line, with a barrier layer against gases, water vapor, or organic substances, the barrier layer consisting of a material specific to the container contents and being applied on the outside of the filled plastic container including its closure after its filling, the barrier layer consisting preferably of SiOₓC_{y}H_{z} or TiOₓC_{y}H_{z} or of mixtures of Si and Ti compounds; this known coating technology requires only one continuous coating station with a vacuum means and a linear plasma source which is produced by microwave antennas. Even if the microwave configuration typically has standard components in 2.45 GHz technology, the pertinent known coating process is complex in terms of hardware and thus leads to an increase of production costs.

The object of the invention therefore is to further improve a process of the initially mentioned type such that with low production effort and thus with low costs a container is formed which has effective barrier layers against gases and vapors, especially against oxygen, carbon dioxide, water vapor, solvents, and aromatic substances. This object is achieved by a process having the features specified in claim 1 in its entirety.

In that, as specified in the characterizing part of claim 1, for extrusion of different plastic materials a coextrusion process is employed in which the respective container is built up at least partially from several layers of plastic material and that at least one of the layers is used as a barrier layer, the former necessity of additional repackaging for a container produced in this way is obviated and also inert gas filling of the repackaging can be omitted. If the barrier layer is also able to meet other requirements which are imposed on the wall of the container, it is sufficient to provide coextrusion of at least two layers. In many cases however, to meet the imposed requirements and/or for reasons of economy, it is however advantageous to form the tube by coextrusion from two or more layers which can then consist of materials, especially plastic materials, with different properties. With the combined “blowform-fill-seal process” as claimed in the invention and the coextrusion of the plastic material, with little production effort and thus economically at high operating speed it becomes possible to provide filled and sealed containers with at least one barrier layer such that the plastic container wall is hermetically tight against gases or vapors, especially against oxygen, carbon dioxide, water vapor, solvents, and aromatic substances. The latter also contributes to sterility being maintained for the container medium in aseptic filling of the container.

Since only tubes can be extruded which consist of a single plastic layer with the known machines for producing filled and sealed containers, the object of the invention is to devise a device which allows cost-effective coextrusion. This object is achieved by a device with the features specified in claim 6 in its entirety.

The assignment of the extrusion head and the pertinent extruder on the one hand and of the mold-fill-seal means on the other to separate device locations makes it possible on the one hand to easily accommodate the increased number of components and on the other in this way different extrusion units can be combined with different mold-fill-seal means, enabling adaptation to different requirements without difficulties. But preferably it is provided here that adapter or nozzle coextrusion be done with only one extrusion head of the device component, so that in this way different plastic materials can be combined with each other into layers as the container wall without the need for separate extrusion heads for each.

Other advantageous embodiments of the process as claimed in the invention and the device are the subject matter of the other dependent claims.

The process as claimed in the invention will be detailed below using one example of the device as shown in the drawings. The single FIGURE schematically shows in a perspective top view a blow-fill-seal machine with a coextrusion unit, not to scale.

The device which is shown in the FIGURE for producing filled and sealed containers, for example ampules filled with a pharmaceutical preparation, has a first device component which is designated as a whole as 10 and which bears the extruder 12, in this exemplary embodiment two extruders 12 being used. The extruders 12 can have a different size; but in this case the two extruders 12 are made essentially the same size, i.e., they deliver to the common extrusion head 14 the same volumetric flow of plastic material which is to be added. Accordingly the extruders 12 are at a common supply height with the top of the actual extrusion head 14. The pertinent extruder head or extrusion head 14 on its bottom has an exit opening for the plastic tube and the extrusion head 14 enables coextrusion of two common layers which form the tube and which are made available by way of the extruders 12.

The specified extrusion head 14 which is not detailed can enable so-called nozzle coextrusion in which the plastic melts from the respective extruder 12 are supplied to a multilayer nozzle which is not detailed, in the extrusion head 14. This multilayer nozzle combines several individual nozzles and the melts are combined shortly in front of the nozzle gap. This nozzle coextrusion has proven especially advantageous when the number of container layers is small, as in the present case, two. In adapter coextrusion the melt flows from the different extruders 12 are supplied to a common channel in the extrusion head 14. The indicated adapter provides for the combined melt flows being able to flow laminarly and with the pertinent adapter coextrusion seven to nine layers on the container walls can be produced.

That side of the device component 10 over which the extruders 12 project is connected to a second device component which is designated as a whole as 16 and which bears the blow-fill-seal means with which the so-called “Bottelpack®” process can be carried out, which is characterized in that a hollow body is blown as a container, it is immediately filled and then preferably aseptically and hermetically sealed. For pharmaceutical application the classical Bottelpack® process is modified such that the hollow body (container) is blown with sterile filtered air, the contents (media) are themselves aseptically added and the containers are then sealed still hot. This Bottelpack® process is relevantly known and is described in a plurality of patents, such as for example DE 38 32 566 C2, DE 1 297 525, DE 1 272 807, etc., so that it will not be detailed here. But it is characteristic of the indicated means that it has a blow mold which is divided in the vertical direction and which can be positioned underneath the extrusion head 14.

After the plastic tube emerging from the extruder head or extrusion head 14 has reached a length such that its lower end extends to the bottom end of the blow mold, it is closed. In this position of the blow mold then the container, also in the form of an ampule or the like, is filled with the medium and then sealed (hermetically).

Power is supplied to all assemblies by way of a central control cabinet 18 which also contains all the controls. The control cabinet 18 constitutes a separate component which can be set up wherever it is most advantageous. In this exemplary embodiment the control cabinet 18 is next to the first device component 10 connected to the back of the second device component 16. By means of a partition or a separating system (dark/white side concept) the system components which produce dirt can be combined for example in a system cabinet and in this way do not adversely affect the other system parts, whereby a type of clean room production can be accomplished.

The individual layers of the container product are formed from different plastic materials, especially from polyolefin, polyamide (PA), polypropylene (PP), low density polyethylene (LDPE), copolymer (COP), and ethylene vinyl alcohol copolymer (EVOH). Especially EVOH and other copolymers have proven effective as barrier layers for oxygen, aromas, water vapor, and comparable media. In this embodiment in which the two extruders 12 make available two layers of plastic materials, an optical as well as oxygen and aroma barrier is achieved in that the inner container wall consists of polypropylene and the outer container wall consists of a polyamide material. Alternatively it can be provided that instead of the inner container wall of polypropylene, there is one of low density polyethylene. Preferably it is furthermore provided that the indicated layers are joined to each other by way of an adhesive which is likewise introduced by way of the extrusion head 14. Ionomers have proven especially advantageous as adhesives. The indicated layers can be made as thin layers with a wall thickness <200 μm, and still very good sealing and barrier behavior is achieved.

To obtain an oxygen barrier in addition to an aroma barrier, it has proven advantageous to make the innermost container wall of low density polyethylene or of polypropylene, then to connect it by way of an adhesive EVOH in order to then in turn form the outer container wall by way of an adhesive, whether in the form of low density polypropylene or in the form of low density polyethylene. Polyolefin materials and copolymers have proven advantageous for obtaining a water vapor barrier. Thus for example for a water vapor barrier the inner container wall can be built up from a copolymer and the outer layer consists of low density polyethylene (LDPE). For each layer medium to be added another extruder (not shown) is then necessary.

To open the respective container (ampule) the head parts of the container are used which can preferably be separated from the container opening by way of a toggle and a point of separation. Compared to the known monolayer carrier layers, it has been found that the opening torque for the toggle is greater, if multilayer containers are coextruded and further processed using the Bottelpack® process. In particular it has been found that the twist-off torques for the toggle closure for low density polyethylene are smaller than those of copolymer layers which form the inner wall of the container in conjunction with the low density polyethylene layers and that the pertinent twist-off torque is in turn smaller than if the multiple layers are built up from polypropylene materials. Accordingly, by way of using suitable layer materials the twist-off torque for the toggle piece of the container head can be adjusted depending on the user within a definable framework. This opening torque is also determined by the geometries, wall thicknesses, and opening cross sections of the container.

It has proven especially favorable in a multilayer structure of a container to pay attention to the fact that for example oxygen barrier layers are combined with water vapor-barrier layers, for example such that the oxygen barrier layer is held between two water vapor-barrier layers. With the process as claimed in the invention, in addition to the device several containers (ampules) can be coextruded, blown, filled, and hermetically sealed with high output rates and at the same time in a row next to each other.

1. Method for producing at least one container of a plastic material filled with a medium, in which
the plastic material is extruded in a tubular shape and is placed against the inside walls of a molding tool for molding the respective container by means of differential pressure,
the respective container is filled with the medium by way of its fill opening with a filling means and
the fill opening of the container is closed by sealing,
characterized in that for extrusion of different plastic materials a coextrusion process is used in which the respective container is built up at least partially from several layers of plastic material and that at least one of the layers is used as a barrier layer

2. The process as claimed in claim 1, wherein the individual layers of the container product are formed from different plastic materials, especially from polyolefin, polyamide, polypropylene, low density polyethylene, copolymers, and ethylene vinyl alcohol copolymers.

3. The process as claimed in claim 2, wherein ethylene vinyl alcohol copolymers and other copolymers are used on the container as barrier layers for oxygen, aromas, water vapor, solvents, and toxic substances.

4. The process as claimed in claim 1, wherein at least two layers, especially more than three, preferably five and more barrier layers are used for a container.

5. The process as claimed in claim 1, wherein adhesives such as ionomers are used between the layers of plastic materials.

6. Device for carrying out the process as claimed in claim 1, wherein the device component (10) has at least one extrusion head (14) and for each provided layer an extruder (12) and wherein the other device component (16) has at least one mold-fill-seal means.

7. The device as claimed in claim 6, wherein the extrusion head (14) enables adapter or nozzle coextrusion.
